(19) United States
(12) Patent Application Publication
(10) Pub. No.: US 2026/0132921 A1
(43) Pub. Date: May 14, 2026

(54) COMBINED CYCLE NUCLEAR POWER PLANT

(71) Applicant: NuScale Power, LLC, Corvallis, OR (US)

(72) Inventor: Larry Hu, Bellevue, MI (US)

(21) Appl. No.: 19/388,776

(22) Filed: Nov. 13, 2025

Related U.S. Application Data
(60) Provisional application No. 63/720,350, filed on Nov. 14, 2024.

(51) Int. Cl. F22B 37/00; F22B 1/12; G21D 1/00

(52) U.S. Cl. CPC F22B 37/002; F22B 1/123; G21D 1/006

(57) ABSTRACT

A nuclear power plant comprising at least one nuclear reactor having a steam generator, a steam cycle including the steam generator, a first turbine fluidly coupled to the steam generator, a first condenser fluidly coupled to the first turbine, and a feedwater heater fluidly coupled to the first condenser and the steam generator, an intermediate thermal loop including the first condenser, and an evaporator, and an organic cycle including the evaporator, a second turbine fluidly coupled to the evaporator, a second condenser fluidly coupled to the second turbine, and a heat exchanger fluidly coupled to the second condenser and the evaporator.

### CROSS-REFERENCE TO RELATED APPLICATIONS

This application claims priority to U.S. Provisional Patent Application No. 63/720,350, filed Nov. 14, 2024, and titled “Combined Cycle Nuclear Power Plant,” which is incorporated herein by reference in its entirety.

### BACKGROUND

Steam driven power plants (e.g., coal, gas, nuclear, etc.), utilizing the Steam Rankine Cycle (SRC), have an inherent temperature limit for rejecting heat to the cold reservoir. A suitable difference in steam turbine exhaust temperature and cold reservoir temperature is necessary to facilitate SRC heat rejection to the cold reservoir. Steam's high specific volume, low vapor pressure, and high wetness at steam turbine exhaust temperatures below 90-100° F. prohibit steam turbines from increasing in gross electric power when the cold reservoir temperature drops below approximately 60-70° F. Low temperature turbine exhaust steam is a key limitation of steam turbine technology, which at present, does not provide efficient conversion of low temperature wet steam to electrical power. In order to increase electric power generation for steam systems when the cold reservoir temperatures are relatively low, innovation is necessary.

### BRIEF DESCRIPTION OF THE DRAWINGS

FIG. 1A schematically illustrates a representation of a combined cycle nuclear power plant incorporating an intermediate thermal loop, according to an embodiment of this disclosure.

FIG. 1B schematically illustrates a representation of a combined cycle nuclear power plant incorporating a double-walled heat exchanger, according to an embodiment of this disclosure.

FIG. 2 illustrates a portion of the combined cycle nuclear power plant of FIG. 1A, according to an embodiment of this disclosure.

FIG. 3 illustrates a portion of the combined cycle nuclear power plant of FIG. 1A, according to an embodiment of this disclosure.

FIG. 4 is a graph illustrating the gross electric power output of a combined cycle nuclear power plant relative to the outdoor ambient temperature, according to an embodiment of this disclosure.

FIG. 5 is a partially schematic, partially cross-sectional view of a nuclear reactor system, according to an embodiment of this disclosure.

FIG. 6 is a partial schematic, partial cross-sectional view of a nuclear reactor system, according to an embodiment of this disclosure.

FIG. 7 is a schematic view of a nuclear power plant system including multiple nuclear reactors, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to traditional and/or advanced nuclear reactors (e.g., small modular nuclear reactors (SMRs), etc.), that may implement any Organic Rankine Cycle (ORC) technology for the purpose of increasing thermodynamic efficiency of the nuclear steam supply system (NSSS), relative to traditional and/or advanced nuclear reactors that implement a Steam Rankine Cycle (SRC). The benefit of increased efficiency is intended to enhance the nuclear power plant's capability for providing heat, electric power, and/or electric ancillary services.

The thermal efficiency (i.e., the fraction of thermal power converted to electric power) of a thermal power plant increases as the heat rejection temperature to the cold reservoir decreases. For power plants utilizing the Rankine cycle, the cold reservoir is the power plant's heat sink that provides cooling necessary for condensing the turbine exhaust flow. For example, a cold reservoir may consist of a lake, river, ocean, or the atmosphere. Due to the influence of weather, the temperature of the cold reservoir is lower in the winter and higher in the summer.

In an embodiment, a combined cycle nuclear power plant (NPP) supplies nuclear heat to the SRC, and the condensation of steam turbine exhaust generates heat which is transferred to an Organic Rankine Cycle (ORC) power system (e.g., power plant 100A, power plant 100B). ORC power systems are an established technology widely used in geothermal power plants. ORC power cycles employ an organic fluid to drive an ORC turbine. Organic fluids do not have the same cold turbine exhaust limitations as steam and can therefore be used as a “bottom cycle” to maintain the inverse proportionality between the combined cycle NPP's gross electric power and the cold reservoir temperature. In an embodiment, the combined cycles of SRC and ORC allow the combined cycle NPP's gross electric power to increase as the cold reservoir temperature decreases, even when reservoir temperatures drop below 60-70° F. In an embodiment, the cold reservoir provides cooling to the plant's condenser (e.g., ORC condenser 204).

Renewable Energy (RE) suffers from either poor winter capacity factor (e.g., solar) or poor reliability during peak winter conditions (e.g., wind). In an embodiment, a nuclear power plant (NPP) with higher cold weather output would effectively render cold weather as a new renewable resource for dispatchable carbon free generation. The embodiment serves to complement RE and could minimize the size of power curtailments that typically occur from overbuilding a single RE resource. The combined cycle NPP (e.g., power plant 100A, power plant 100B) can bolster both winter electric generation and winter grid reliability. The combined cycle NPP serves to counter the loss of winter electric grid reliability caused by over replacement of firm dispatchable generation assets with intermittent RE technology.

Fossil-fueled electric generation can also be challenged during cold winter seasons. A significant number of fossil-fueled power plants are needed when peak winter conditions cause excess demand for electricity. Wintertime risks associated with fossil fueled generation include the freezing of natural gas wells and/or coal stockpiles, insufficient winter hardening of fossil power plants, and the prioritized allocation of natural gas supplies to public home heating (e.g., diverting supplies away from natural gas plants).

For some regions, maintaining the electric grid during winter requires multiple reserve fossil power plants that can be supplied by two or more fuel types (e.g., dual fuel power plants). As one type of fuel is lost (e.g., natural gas to public consumption or otherwise), the dual fuel power plant switches to an alternate fossil fuel (e.g., fuel oil, kerosene, etc.). The combined cycle NPP serves to reduce the grid's exposure to risks associated with wintertime fossil fuel generation.

A combined cycle NPP (e.g., power plant 100A, power plant 100B) provides a level of winter energy security that cannot be matched by a regular NPP (i.e., a NPP that does not incorporate an ORC). A regular NPP operates independent of weather with a virtually constant gross electric power output. In an embodiment, the combined cycle NPP operating in 0-10° F. ambient air temperature generates electrical power substantially exceeding the electric output of a regular NPP.

In an embodiment, the annual electric generation is greater than a regular NPP in areas with mild or cold winters. In an embodiment, the amount of spent nuclear fuel per generated electric energy (e.g., GWe-year) is reduced compared to a regular NPP in areas with mild or cold winters. In an embodiment, the levelized cost of energy (LCOE) (i.e., average cost of electricity over the life of the power plant) is also improved, relative to a regular NPP, for parts of the world that have mild or cold winters.

A regular baseload NPP (one that does not incorporate an ORC power system) may replace one or more annual baseload power plants (power plants that operate at full power for the entire year). In an embodiment, a combined cycle NPP may simultaneously replace a set of annual baseload, cold seasonal baseload, and winter peaking power plants.

Cold seasonal baseload plants operate during periods of ambient temperature below approximately 50-65° F. and increase in electric output to supply the increasing demand when weather becomes colder. Winter peaking plants are power plants that operate to maintain the electric grid when winter electric demand is highest (e.g., during the coldest days of the year). The combined cycle NPP provides a means for supplying increased winter demand while reducing winter seasonal baseload and/or winter peaking power operations, thereby reducing costs for energy utilities. This cost reduction allows the combined cycle NPP to provide a new value stream to energy utilities, which is realized when winter electric power can be provided without relying on power generation assets that run on a seasonal part-time basis.

The cost benefit realized by the embodiment occurs upon initial operation of the combined cycle NPP. This immediate cost benefit (from reduction or elimination of part-time winter generation assets) is a substantial improvement over the cost benefit of a regular nuclear plant. The regular NPP (e.g., without an ORC power system) achieves a relatively low cost of electricity after completion of construction, capital and finance cost payments, and completion of such payments often requires multiple decades. By avoiding the need for winter seasonal baseload and winter peaking power plants, the combined cycle NPP can achieve lower electricity costs on its first day of operation.

In an embodiment, the combined cycle NPP (e.g., power plant 100A and 100B) employs a steam turbine (e.g., condensing or backpressure type) and an ORC turbine. ORC turbines can ramp up or down in gross electric power output at a faster rate than steam turbines. Using a steam turbine and ORC turbine will allow the combined cycle NPP to load follow at a faster rate than traditional NPPs using only condensing steam turbines.

In an embodiment, a combined cycle nuclear power plant (e.g., power plant 100A and 100B) may also benefit from the following observations:
a) Operation of the ORC turbine does not require the steam turbine to remain online. Steam turbine bypass allows for heat rejection to the ORC while the steam turbine is offline. Similarly, operation of the steam turbine does not require the ORC turbine to remain online since heat from SRC condensation is rejected to the ORC fluid with the ORC turbine bypassed (heated ORC fluid is then directed to the ORC condenser for final heat rejection to the cold reservoir). The ability to perform either SRC or ORC turbine maintenance while providing electrical power allows the combined cycle NPP to offer a higher level of plant reliability than a regular NPP.
b) The combined cycle NPP is capable of rejecting steam heat to the ORC power system during reactor startup, thus allowing the ORC power system to provide electric power before the steam turbine is ready to accept steam heat. The combined cycle NPP provides a new method for shortening the duration of a refueling outage, as measured from time of shutdown to time when electric power is first supplied to the grid.
c) The combined cycle NPP allows for increased usage of open feedwater heating (i.e., direct mixing of turbine extraction steam to cold feedwater) in the steam cycle. Since steam turbine exhaust temperature (and thus, condensation temperature) can be higher for the combined cycle than a regular NPP (as needed to transfer heat to the ORC system), the function to raise SRC feed water temperature may be accomplished from the sole usage of a few open feedwater heaters. The use of open feedwater heaters provides for a higher SRC thermal efficiency than with closed feedwater heating (i.e., transfer of steam heat to feedwater through a shell-and-tube heat exchanger).
d) A light water reactor (LWR) nuclear power plant typically employs a Moisture Separator Reheater (MSR), where a portion of the NPP's main steam is diverted away from the turbine to reheat high pressure (HP) turbine exhaust steam. This arrangement requires sacrifice of some main steam for reheating the wet HP turbine exhaust steam into a dry low pressure (LP) superheated steam. This arrangement is meant to protect the steam turbine from encountering excessively wet steam, which can damage the LP steam turbine. In the embodiment, the need for a MSR can be avoided since steam turbine exhaust can be condensed at a higher temperature, where steam wetness levels are lower and within acceptable limits for preventing damage to the steam turbine.
e) Wetness in the steam turbine also lowers turbine efficiency. While MSRs provide a small increase in thermal efficiency (by reducing wetness in the low-pressure turbine sections), the increase in thermal efficiency comes at the cost of diverting main steam away from the turbine. The combined cycle NPP avoids the need for LP steam turbine(s), which are replaced by high efficiency ORC turbine(s). Thermodynamic losses associated with heat transfer (from condensing steam to the ORC system) are offset by gains realized through:
   i) an increased steam flow to the high-pressure steam turbine (no diverting nuclear supplied steam to the MSR),
   ii) the avoidance of losses in electric power associated with low-pressure wet steam,
   iii) the usage of ORC turbine(s) which are typically characterized by high isentropic turbine efficiency,
   iv) allowance of at least 1 SRC closed feedwater heater to be replaced by an open feedwater heater,
   v) the use of ORC technology for improving thermal efficiency of the ORC power system (such as recuperators and regen heaters),
   vi) the potential use of heat pumps in the ORC system, and
   vii) heat rejection at a lower condenser temperature than steam (with electric power increasing as weather gets colder).

In an embodiment, a combined cycle nuclear power plant combines two separate vapor power cycles. The first vapor power cycle (“top cycle”) is the original Steam Rankine Cycle (SRC) currently used in nuclear power. The second vapor power cycle (“bottom cycle”) is the Organic Rankine Cycle (ORC) used primarily in geothermal and waste-to-heat power plants. The purpose of adding an ORC power cycle to the SRC is to better utilize the low-grade heat that is rejected by a nuclear power plant's main condenser in the top cycle. Rejected heat, as supplied from the condensation of turbine exhaust steam (e.g., the latent heat released in the main condenser), is normally transferred into a cold reservoir.

In an embodiment, to overcome the heat rejection temperature limits associated with a power plant utilizing only an SRC, incorporating an ORC power cycle within the power plant may increase the power plant's electric power output when the cold reservoir temperature decreases during cold weather (e.g., fall, winter, etc.). In an embodiment, an ORC may be used to recover low grade heat, similar to binary cycle geothermal power plants. In an embodiment, a power plant utilizing an ORC power system may employ the same basic principles and components as a power plant utilizing an SRC (both are Rankine power cycles). However, an ORC utilizes an organic fluid (e.g., hydrocarbon, refrigerant, etc.) instead of steam to drive a turbine.

In an embodiment, organic fluids boil into vapor at lower temperatures than water boils into steam (at a given pressure). Additionally, several organic fluids used in ORC power systems remain dry throughout turbine expansion, and thus, do not have the same cold temperature limitations as steam. Because organic fluids do not have the same cold temperature limitations as steam, an ORC may be incorporated in a power plant to recover thermal energy from a fluid system at relatively low temperatures. For example, a nuclear power plant may implement an SRC as a primary method for removing thermal energy from nuclear fuel (e.g., top cycle, primary cycle, first cycle, etc.). The steam exiting the top cycle will be at a temperature too low for a subsequent SRC to be productive, so an ORC may be used as a secondary method for removing any remaining thermal energy (e.g., bottom cycle, secondary cycle, second cycle, etc.). In an embodiment, an ORC may be used as a bottom cycle within a nuclear power plant in order to maintain the inverse proportionality between gross electric power and cold reservoir temperature (e.g., gross electric power increases as outdoor temperature decreases).

In an embodiment, a single ORC turbine may be suitable for increasing the cold weather thermal efficiency of a SMR. In an embodiment, the steam power cycle (i.e., SRC) of a nuclear power plant (e.g., SMR, etc.) may be combined with an ORC to create a single combined cycle nuclear power plant (e.g., winter peaking power plant (WP3)). Implementing an SRC as a top cycle and an ORC as a bottom cycle would allow a combined cycle nuclear power plant to provide additional electric power during cold weather, without making any changes to the reactor core or the plant's nuclear island (e.g., reactor, radwaste, control buildings, etc.).

Energy security and electric grid reliability during cold weather is an emerging issue for electric utilities and grid operators. The combined effect of closing several dispatchable thermal power generators and replacing them with intermittent renewable energy plants has resulted in significant erosion of regional grid reliability margins during cooler temperatures (e.g., fall, winter, etc.). While the combination of high natural gas availability and excess solar power may effectively respond to peak summer demand, the peak winter demand is often met by a combination of demand response management (e.g., reduction of customer electric load upon request), dual-fuel seasonal baseload power plants, and dual-fuel peaking power plants. Natural gas availability for gas power plants remains challenged due to the high priority allocation of gas to public heating.

Extreme cold weather events have also challenged gas availability due to freeze offs at the gas wellhead, which may ultimately cause depressurization of major gas transmission and distribution lines. Gas plants operating in areas with cold-weather winters must maintain an excess supply of liquid hydrocarbons to provide power when gas becomes unavailable. The operation of dual fuel gas power plants to burn diesel fuel oil to maintain an electrical power supply in these regions has the unwanted effect of increased air pollution. Renewable energy sources such as solar and wind are not reliable enough to provide the peak winter demand load. Solar suffers from poor winter generation and despite wind power generally increasing during the winter, there is no guarantee the wind will blow when demand is high. Wind droughts are known to occur during periods of peak winter demand.

In an embodiment, a combined cycle nuclear power plant may provide a unique carbon free market solution for winter energy security. A combined cycle nuclear power plant is unique because, unlike a traditional nuclear power plant or advanced reactor offering a steam-only power cycle, the combined cycle nuclear power plant may supply both annual baseload power and a surplus of electric power during cold weather. Due to fossil fuel scarcity associated with cold winters, employing a fleet of combined cycle nuclear power plants may serve to increase regional winter energy security by reducing reliance on less dependable fossil-fueled power plants that operate during periods of peak demand only (i.e., peaker power plants). Accordingly, the number of peaker power plants (which often run at less than 15% capacity factor) needed to maintain grid reliability during peak winter demand will be reduced. The combined cycle nuclear power plant offers the benefit of simultaneous reduction in winter air pollution and electric energy costs associated with seasonal baseload and winter peaker plant operation, while increasing regional energy security.

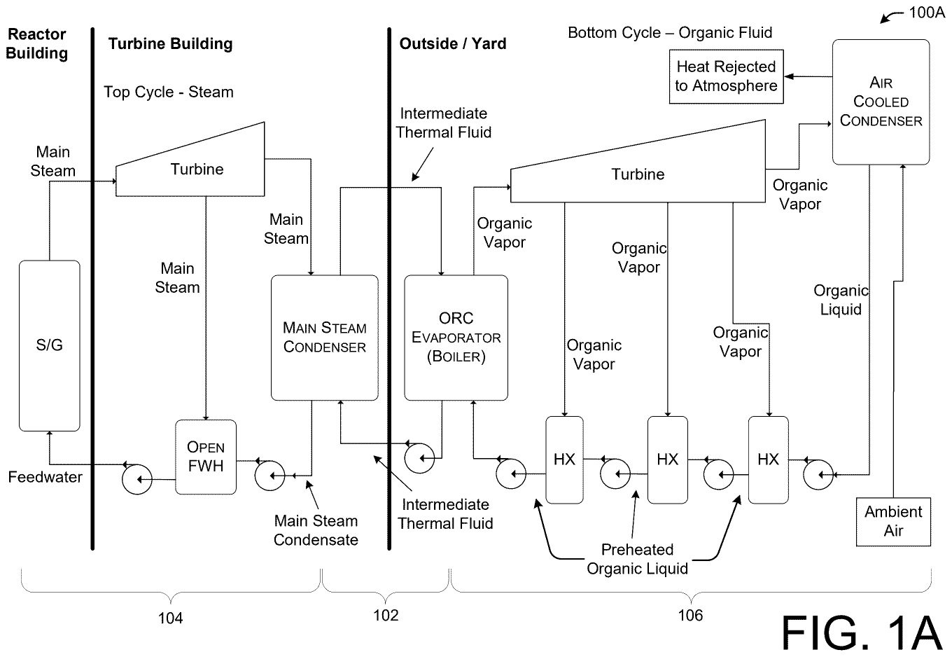

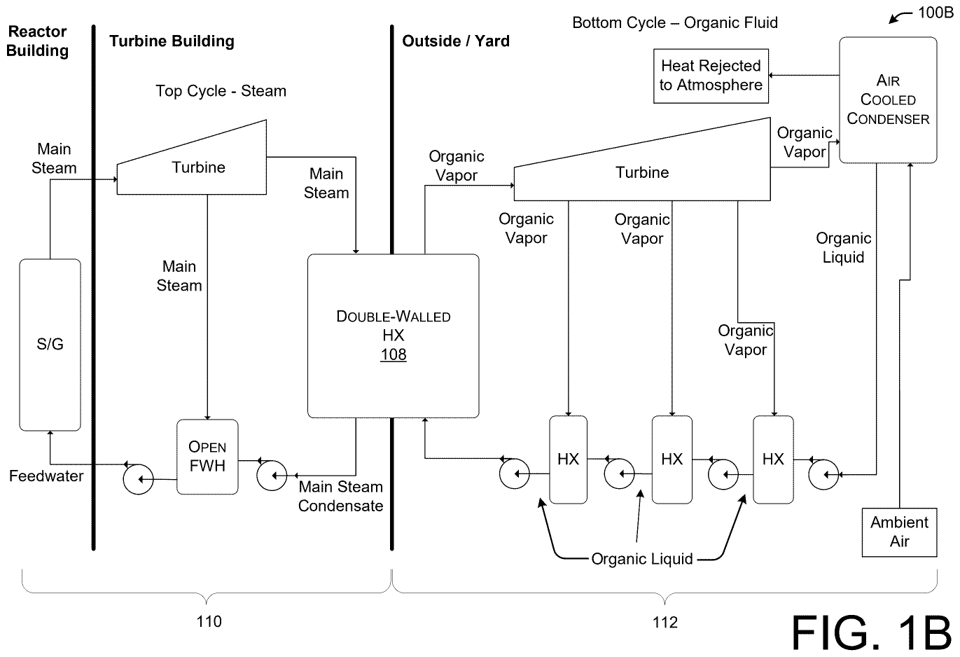

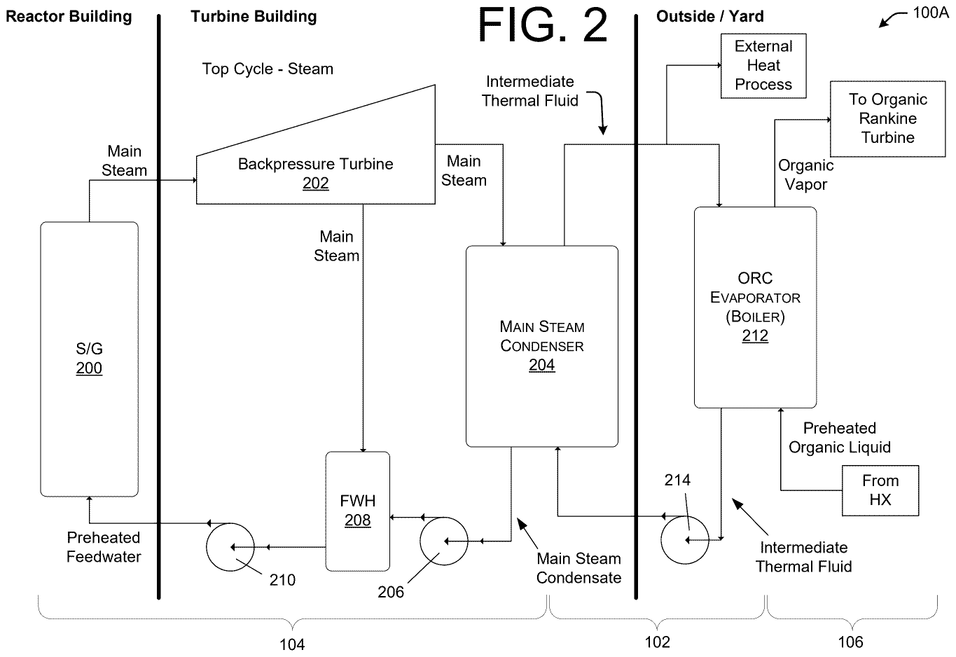

In an embodiment, implementing a combined cycle nuclear power plant may require modification to a traditional SRC. For example, the recirculation system that supplies cooling water to the main steam condenser can be replaced with an intermediate thermal loop (ITL) (see FIG. 1A). The steam condenser can also be replaced by a double-walled heat exchanger that separates the nuclear supplied steam from the organic fluid loop (see FIG. 1B). Both ITL and double-walled heat exchanger configurations assure that no leak or break will result in organic fluid entering the feedwater of the SMR steam generator. In an embodiment, pressure and/or chemical sensors may be installed in the ITL or double-walled heat exchanger to alarm operators of a break in either steam or organic fluid pressure boundaries. The ITL may offer improved plant efficiency in serving a combined heat and power (CHP) load (for supplying both electricity and heat). The ITL contains an intermediate thermal fluid which is a heat carrying fluid (e.g., water/steam, mineral oil, etc.) ideal for transporting heat from the SRC to an external heat process (see FIG. 2). In an embodiment, the double-walled heat exchanger may provide better plant efficiency than the ITL configuration for users that only need electricity.

In an embodiment, a combined cycle nuclear power plant may allow for changing the turbine design from condensing turbine to a backpressure turbine. All light water nuclear power plants use condensing steam turbines. The change to backpressure turbine is optional but may allow heat from higher temperature turbine exhaust steam to be delivered to the ORC system, which may increase plant efficiency. The use of an ORC may also increase the speed of the plant's load following capabilities, since ORC turbines are capable of faster ramp speeds than steam turbines.

In an embodiment, a combined cycle nuclear power plant may allow for the optional use of one or more open ORC regenerative heaters, recuperators, and/or heat pumps, which may improve overall thermal efficiency. Since less ORC turbine extraction flow would be needed to heat the organic feed fluid, a higher percentage of organic vapor may be available for conversion to electricity by the ORC turbine generator.

### Illustrative Embodiments

FIG. 1A schematically illustrates a representation of a combined cycle nuclear power plant 100A (“power plant 100A”) incorporating an intermediate thermal loop 102 (“loop 102”). In an embodiment, the power plant 100A may include a first vapor cycle 104 (e.g., first cycle, top cycle, top vapor cycle, SRC, traditional cycle, etc.) and a second vapor cycle 106 (e.g., second cycle, bottom cycle, bottom vapor cycle, ORC, organic cycle, etc.).

In an embodiment, the top cycle 104 may produce steam (e.g., main steam, first steam, etc.) in a steam generator (S/G), convert the steam to energy via one or more turbines, condense the steam exhausted from the one or more turbines into liquid condensate (e.g., first condensate, etc.), via a main condenser, preheat the liquid condensate using a portion of the steam from the one or more turbines, via a feedwater heater, to generate preheated feedwater, then return the preheated feedwater back to the S/G to produce more steam.

In an embodiment, the loop 102 may receive heat from the top cycle 104 and produce heated intermediate thermal fluid (e.g., steam, heated water, heated mineral oil, etc.), via the main condenser, heat the intermediate thermal fluid for transfer into an external heat process and/or ORC system, and return the cooled intermediate thermal fluid to the main steam condenser for reheating the intermediate thermal fluid.

In an embodiment, the bottom cycle 106 may absorb heat from the loop 102 and produce an organic vapor (i.e., vaporized refrigerant, gaseous refrigerant, or any other appropriate gaseous organic fluid), via an ORC evaporator (e.g., boiler, heat exchanger, etc.), convert the organic vapor to energy via one or more turbines, direct the exhaust organic vapor to a condenser, to condense the organic vapor, via a condenser (e.g., an air cooled condenser, wet-cooled condenser, etc.), into an organic liquid (e.g., organic condensate, etc.), preheat the organic liquid with one or more heat exchangers (HX) to produce a preheated organic liquid, and return the preheated organic liquid to the ORC evaporator to produce more organic vapor. In an embodiment, the power plant 100A may include any number of heat exchangers for preheating the organic liquid to generate preheated organic liquid (i.e., 1, 2, 3, 4, etc.).

In an embodiment, the main steam may be generated in a reactor building. In an embodiment, the main steam may be processed, and intermediate thermal fluid may be heated in a turbine building. In an embodiment, the intermediate thermal fluid may be processed, and the organic vapor may be produced and processed outside. Although the power plant 100A is depicted in FIG. 1A as occupying a reactor building, a turbine building, and outside, the power plant 100A may be in any number of buildings, rooms, or any other arrangement as allowed by design and regulatory restrictions and/or constraints.

FIG. 1B schematically illustrates a representation of a combined cycle nuclear power plant 100B (“power plant 100B”) incorporating a double-walled heat exchanger 108. In an embodiment, the power plant 100B may include a first vapor cycle 110 (e.g., first cycle, top cycle, top vapor cycle, SRC, traditional cycle, etc.) and a second vapor cycle 112 (e.g., second cycle, bottom cycle, bottom vapor cycle, ORC, organic cycle, etc.).

In an embodiment, the first vapor (top) cycle 110 may produce steam (e.g., main steam, first steam, etc.) in a steam generator (S/G), convert the steam to energy via one or more turbines, condense the steam exhausted from the one or more turbines into liquid condensate (e.g., first condensate, etc.), via the double-walled heat exchanger 108, preheat the liquid condensate using a portion of the steam from the one or more turbines, via a feedwater heater (Open FWH), to generate preheated feedwater, then return the preheated feedwater back to the S/G to produce more steam.

In an embodiment, the main steam may be generated in a reactor building. In an embodiment, the main steam may be processed in, and organic vapor may be produced in, a turbine building. In an embodiment, the double-walled heat exchanger 108 may be in the turbine building, outside of the turbine building, or be partially disposed within the turbine building. In an embodiment, the organic vapor may be processed outside. Although the power plant 100B is depicted in FIG. 1B as occupying a reactor building, a turbine building, and outside, the power plant 100B may be in any number of buildings, rooms, or any other arrangement as allowed by design and regulatory restrictions and/or constraints.

FIG. 2 illustrates a portion of the combined cycle nuclear power plant 100A of FIG. 1A.

In an embodiment, the top cycle 104 may include a steam generator (S/G) 200, a backpressure turbine 202 (e.g., first turbine, main turbine, steam turbine, etc.), a main steam condenser 204, a condensate pump 206, a feedwater heater 208 (e.g., first heat exchanger, first heater, etc.), a feedwater pump 210 (e.g., first feedwater pump, and first feed pump, etc.). In an embodiment, the condensate pump 206 and/or the feedwater pump 210 may include any suitable liquid pump (e.g., single-stage, multi-stage, centrifugal, positive displacement, motor driven, steam driven, etc.). In an embodiment, the power plant 100A may include one or more backpressure turbines and/or one or more condensing turbines. In an embodiment, the power plant 100A may include one or more turbines capable of operating as a backpressure and as a condensing turbine.

In an embodiment, the S/G 200 may produce main steam. The main steam may be directed to the backpressure turbine 202. The backpressure turbine 202 may exhaust the main steam to the main steam condenser 204. The main steam condenser 204 may condense the main steam from the backpressure turbine 202 to main steam condensate. In an embodiment, the main steam condensate may be discharged, via the condensate pump 206 to the feedwater heater 208. In an embodiment, the feedwater heater 208 may receive main steam from the backpressure turbine 202 to heat the main steam condensate and generate preheated feedwater. In an embodiment, the feedwater heater 208 may utilize electrical power to generate heat. In an embodiment, the feedwater heater 208 may be an open heater (i.e., main steam is applied directly to the liquid condensate), a closed heater (i.e., shell and tube heat exchanger, or any other suitable heat exchanger wherein the steam is not directly applied to the liquid condensate). In an embodiment, the preheated feedwater may be discharged, via the feedwater pump 210, to the S/G 200.

In an embodiment, heat may be transferred from the top cycle 104 to the loop 102 via the main steam condenser 204. In an embodiment, the loop 102 may include the main steam condenser 204, an ORC evaporator (Boiler) 212, and an intermediate thermal fluid pump 214.

In an embodiment, main steam from the backpressure turbine 202 may be used to heat the intermediate thermal fluid in the main steam condenser 204. The main steam condenser 204 may heat the intermediate thermal fluid by utilizing main steam to heat the intermediate thermal fluid. The intermediate thermal fluid may be directed to the ORC evaporator 212 (e.g., boiler, etc.). The ORC evaporator 212 may receive heat from the heated intermediate thermal fluid to produce cooled intermediate thermal fluid. The cooled intermediate thermal fluid may be supplied, via the intermediate thermal fluid pump 214 to the main steam condenser 204. In an embodiment, a portion or all of the intermediate thermal fluid may be directed to an external heat process (e.g., chemical plant, manufacturing plant, district heating, etc.) as required.

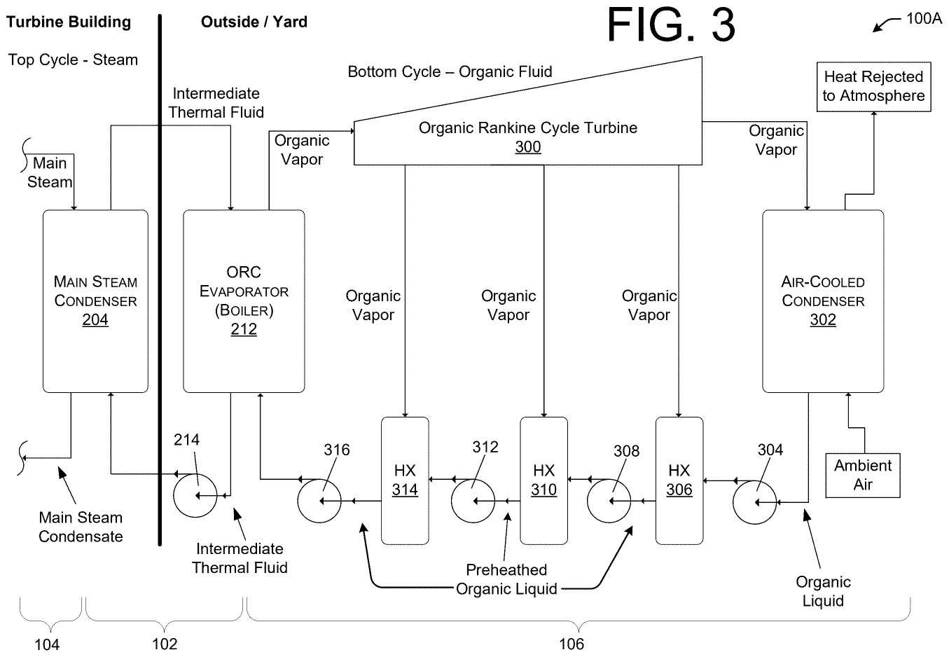

FIG. 3 illustrates a portion of the combined cycle nuclear power plant 100A of FIG. 1A. In an embodiment, heat may be transferred from the loop 102 to the bottom cycle 106 via the ORC evaporator 212.

In an embodiment, the bottom cycle 106 may include the ORC evaporator 212, an ORC turbine 300, an air-cooled condenser 302, a first organic liquid pump 304, a first organic liquid preheater 306 (e.g., first heat exchanger, etc.), a second organic liquid pump 308, a second organic liquid preheater 310 (e.g., second heat exchanger, etc.), a third organic liquid pump 312, a third organic liquid preheater 314 (e.g., third heat exchanger, etc.), and a fourth organic liquid pump 316.

In an embodiment, the heated intermediate thermal fluid may transfer heat into the organic fluid (e.g., refrigerant, etc.) in the ORC evaporator 212. As the intermediate thermal fluid cools inside the ORC evaporator 212, and heat is transferred from the intermediate thermal fluid into the organic liquid within the ORC evaporator 212, the organic fluid may be evaporated into an organic vapor. The organic vapor may contain enough heat energy to run the ORC turbine 300. The organic vapor emanating from the ORC turbine 300 may be directed to the air-cooled condenser 302. In an embodiment, the air-cooled condenser 302 may receive ambient air, the ambient air may absorb heat from the organic vapor. The organic vapor may transfer sufficient heat to the air such that the organic vapor is condensed into an organic liquid. After absorbing heat from the organic vapor, the air within the air-cooled condenser 302 may be discharged back into the atmosphere.

In an embodiment, the organic liquid may be directed, via the first organic liquid pump 304, to the first organic liquid preheater 306. In an embodiment, a portion of the organic vapor (e.g., first portion, etc.) may be directed from the ORC turbine 300 to the first organic liquid preheater 306 to generate a preheated organic liquid at a first temperature. In an embodiment, the first organic liquid preheater 306 may be an open heat exchanger. In an embodiment, the first organic liquid preheater 306 may be a close heat exchanger. In an embodiment, the first organic liquid preheater 306 may be an electric heater.

The preheated organic liquid may be directed, via the second organic liquid pump 308, from the first organic liquid preheater 306, to the second organic liquid preheater 310. In an embodiment, a portion of the organic vapor (e.g., second portion, etc.) may be directed from the ORC turbine 300 to the second organic liquid preheater 310 to generate a preheated organic liquid at a second temperature. In an embodiment, the second organic liquid preheater 310 may be an open heat exchanger. In an embodiment, the second organic liquid preheater 310 may be a close heat exchanger. In an embodiment, the second organic liquid preheater 310 may be an electric heater (e.g., heat pump).

The preheated organic liquid may be directed, via the third organic liquid pump 312, from the second organic liquid preheater 310, to the third organic liquid preheater 314. In an embodiment, a portion of the organic vapor (e.g., third portion, etc.) may be directed from the ORC turbine 300 to the third organic liquid preheater 314 to generate a preheated organic liquid at a third temperature. In an embodiment, the third organic liquid preheater 314 may be an open heat exchanger. In an embodiment, the third organic liquid preheater 314 may be a close heat exchanger. In an embodiment, the third organic liquid preheater 314 may be an electric heater.

In an embodiment, the preheated organic liquid at the third temperature may be directed, via the fourth organic liquid pump 316, from the third organic liquid preheater 314, to the ORC evaporator 212.

In an embodiment, the exhaust temperature of the ORC turbine 300 may be established by a cold reservoir (similar to the exhaust of a steam turbine during hot peak summer weather) (e.g., ambient air, lake, or other suitable heat sink). The colder the cold reservoir, the higher the electric output of the ORC turbine 300. However, unlike a steam turbine (e.g., backpressure turbine 202, condensing turbine, etc.), additional gross power for the ORC turbine 300 may be gained with cold reservoir temperatures. Since the gross electric power of the ORC turbine 300 may increase as cold reservoir temperature decreases, the electric output of the power plant 100A may increase as the weather gets colder.

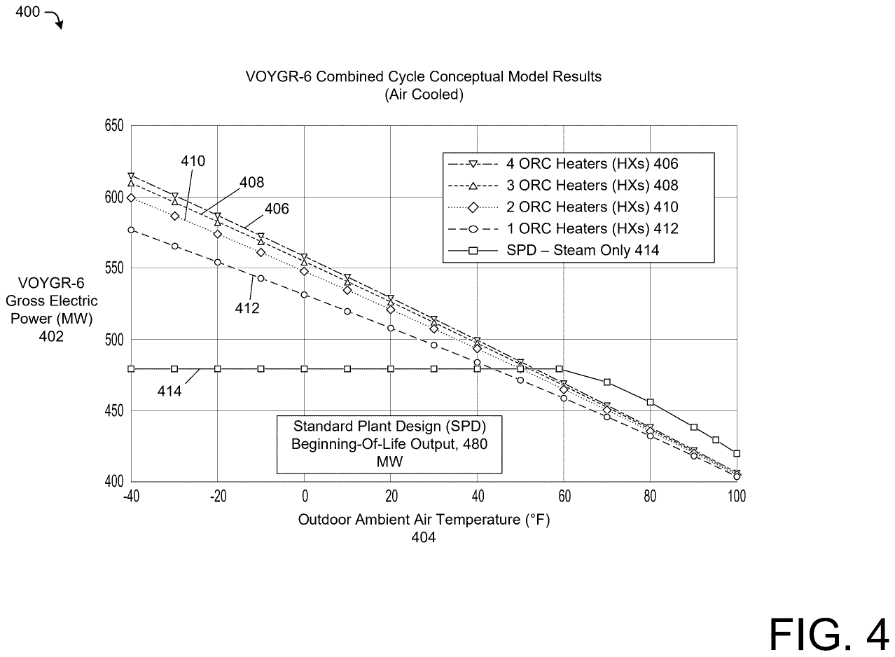

FIG. 4 is a graph 400 illustrating the gross electric power output 402 of a combined cycle nuclear power plant relative to the outdoor ambient temperature 404. The graph 400 may include a line 406 for a power plant (e.g., power plant 100A, power plant 100B) implementing four organic liquid preheaters (e.g., HX 306, HX 310, HX, 314, or any other suitable heat exchanger). The graph 400 may include a line 408 for a power plant (e.g., power plant 100A, power plant 100B) implementing three organic liquid preheaters (e.g., HX 306, HX 310, HX, 314, or any other suitable heat exchanger). The graph 400 may include a line 410 for a power plant (e.g., the power plant 100A, power plant 100B) implementing two organic liquid preheaters (e.g., HX 306, HX 310, HX, 314, or any other suitable heat exchanger). The graph 400 may include a line 412 for a power plant (e.g., power plant 100A, power plant 100B) implementing one organic liquid preheater (e.g., HX 306, HX 310, HX, 314, or any other suitable heat exchanger). The graph 400 may include a line 414 for a power plant (e.g., power plant 100A, power plant 100B) that does not implement any organic liquid preheaters (e.g., HX 306, HX 310, HX, 314, or any other suitable heat exchanger).

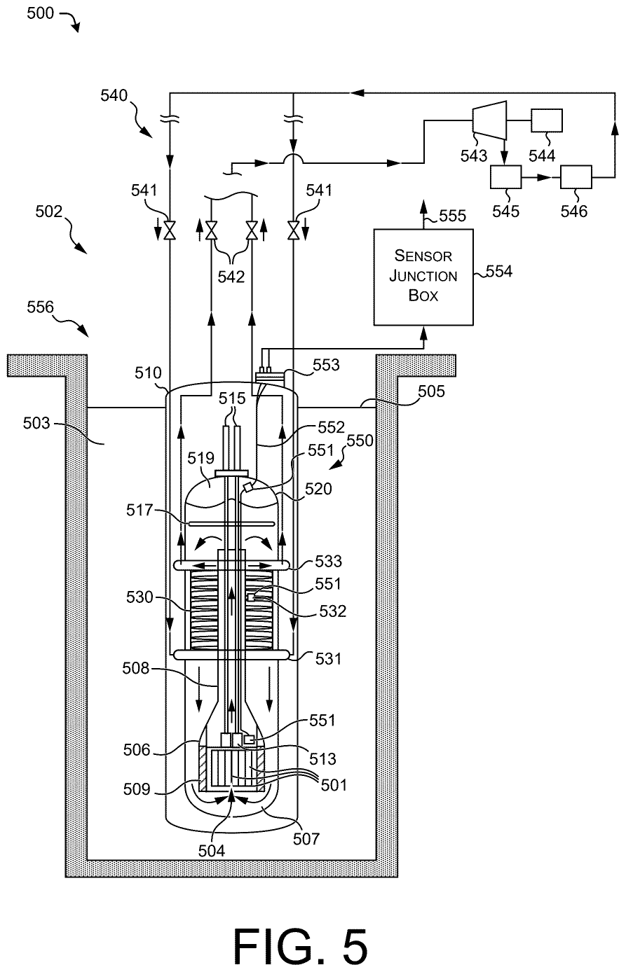

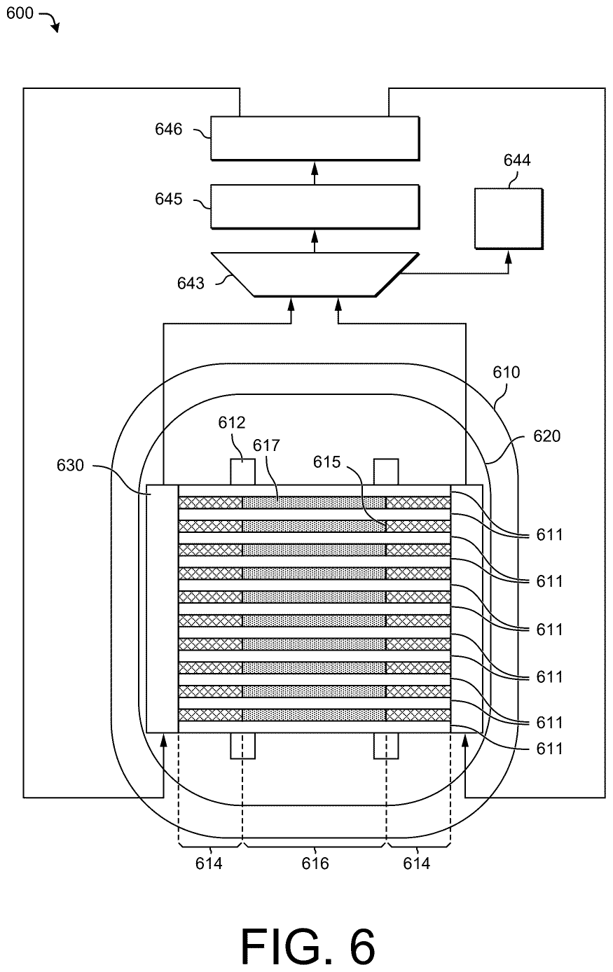

FIGS. 5 and 6 illustrate representative nuclear reactors that may be included in embodiments of the present technology. FIG. 5 is a partially schematic, partially cross-sectional view of a nuclear reactor system 500 configured in accordance with embodiments of the present technology. The system 500 can include a power module 502 having a reactor core 504 in which a controlled nuclear reaction takes place. Accordingly, the reactor core 504 can include one or more fuel assemblies 501. The fuel assemblies 501 can include fissile and/or other suitable materials. Heat from the reaction generates steam at a steam generator 530, which directs the steam to a power conversion system 540. The power conversion system 540 generates electrical power, and/or provides other useful outputs, such as super-heated steam. A sensor system 550 is used to monitor the operation of the power module 502 and/or other system components. The data obtained from the sensor system 550 can be used in real time to control the power module 502, and/or can be used to update the design of the power module 502 and/or other system components.

The power module 502 includes a containment vessel 510 (e.g., a radiation shield vessel, or a radiation shield container) that houses/encloses a reactor vessel 520 (e.g., a reactor pressure vessel, or a reactor pressure container), which in tum houses the reactor core 504. The containment vessel 510 can be housed in a power module bay 556. The power module bay 556 can contain a cooling pool 503 filled with water and/or another suitable cooling liquid. The bulk of the power module 502 can be positioned below a surface 505 of the cooling pool 503. Accordingly, the cooling pool 503 can operate as a thermal sink, for example, in the event of a system malfunction.

A volume between the reactor vessel 520 and the containment vessel 510 can be partially or completely evacuated to reduce heat transfer from the reactor vessel 520 to the surrounding environment (e.g., to the cooling pool 503). However, in other embodiments the volume between the reactor vessel 520 and the containment vessel 510 can be at least partially filled with a gas and/or a liquid that increases heat transfer between the reactor vessel 520 and the containment vessel 510. For example, the volume between the reactor vessel 520 and the containment vessel 510 can be at least partially filled (e.g., flooded with the primary coolant 507) during an emergency operation.

Within the reactor vessel 520, a primary coolant 507 conveys heat from the reactor core 504 to the steam generator 530. For example, as illustrated by arrows located within the reactor vessel 520, the primary coolant 507 is heated at the reactor core 504 toward the bottom of the reactor vessel 520. The heated primary coolant 507 (e.g., water with or without additives) rises from the reactor core 504 through a core shroud 506 and to a riser tube 508. The hot, buoyant primary coolant 507 continues to rise through the riser tube 508, then exits the riser tube 508 and passes downwardly through the steam generator 530. The steam generator 530 includes a multitude of conduits 532 that are arranged circumferentially around the riser tube 508, for example, in a helical pattern, as is shown schematically in FIG. 5. The descending primary coolant 507 transfers heat to a secondary coolant (e.g., water) within the conduits 532, and descends to the bottom of the reactor vessel 520 where the cycle begins again. The cycle can be driven by the changes in the buoyancy of the primary coolant 507, thus reducing or eliminating the need for pumps to move the primary coolant 507.

The steam generator 530 can include a feedwater header 531 at which the incoming secondary coolant enters the steam generator conduits 532. The secondary coolant rises through the conduits 532, converts to vapor (e.g., steam), and is collected at a steam header 533. The steam exits the steam header 533 and is directed to the power conversion system 540.

The power conversion system 540 can include one or more steam valves 542 that regulate the passage of high pressure, high temperature steam from the steam generator 530 to a steam turbine 543. The steam turbine 543 converts the thermal energy of the steam to electricity via a generator 544. The low-pressure steam exiting the turbine 543 is condensed at a condenser 545, and then directed (e.g., via a pump 546) to one or more feedwater valves 541. The feedwater valves 541 control the rate at which the feedwater re-enters the steam generator 530 via the feedwater header 531. In other embodiments, the steam from the steam generator 530 can be routed for direct use in an industrial process, such as a Hydrogen (H₂) and Oxygen (O₂) production plant, a chemical production plant, and/or the like, as described in detail below. Accordingly, steam exiting the steam generator 530 can bypass the power conversion system 540.

The power module 502 includes multiple control systems and associated sensors. For example, the power module 502 can include a hollow cylindrical reflector 509 that directs neutrons back into the reactor core 504 to further the nuclear reaction taking place therein. Control rods 513 are used to modulate the nuclear reaction and are driven via fuel rod drivers 515. The pressure within the reactor vessel 520 can be controlled via a pressurizer plate 517 (which can also serve to direct the primary coolant 507 downwardly through the steam generator 530) by controlling the pressure in a pressurizing volume 519 positioned above the pressurizer plate 517.

The sensor system 550 can include one or more sensors 551 positioned at a variety of locations within the power module 502 and/or elsewhere, for example, to identify operating parameter values and/or changes in parameter values. The data collected by the sensor system 550 can then be used to control the operation of the system 500, and/or to generate design changes for the system 500. For sensors positioned within the containment vessel 510, a sensor link 552 directs data from the sensors to a flange 553 (at which the sensor link 552 exits the containment vessel 510) and directs data to a sensor junction box 554. From there, the sensor data can be routed to one or more controllers and/or other data systems via a data bus 555.

FIG. 6 is a partially schematic, partially cross-sectional view of a nuclear reactor system 600 configured in accordance with additional embodiments of the present technology. In some embodiments, the nuclear reactor system 600 (“system 600”) can include some features that are at least generally similar in structure and function, or identical in structure and function, to the corresponding features of the system 500 described in detail above with reference to FIG. 5, and can operate in a generally similar or identical manner to the system 500.

In the illustrated embodiment, the system 600 includes a reactor vessel 620 and a containment vessel 610 surrounding/enclosing the reactor vessel 620. In some embodiments, the reactor vessel 620 and the containment vessel 610 can be roughly cylinder-shaped or capsule-shaped. The system 600 further includes a plurality of heat pipe layers 611 within the reactor vessel 620. In the illustrated embodiment, the heat pipe layers 611 are spaced apart from and stacked over one another. In some embodiments, the heat pipe layers 611 can be mounted/secured to a common frame 612, a portion of the reactor vessel 620 (e.g., a wall thereof), and/or other suitable structures within the reactor vessel 620. In other embodiments, the heat pipe layers 611 can be directly stacked on top of one another such that each of the heat pipe layers 611 supports and/or is supported by one or more of the other ones of the heat pipe layers 611.

In the illustrated embodiment, the system 600 further includes a shield or reflector region 614 at least partially surrounding a core region 616. The heat pipe layers 611 can be circular, rectilinear, polygonal, and/or can have other shapes, such that the core region 616 has a corresponding three-dimensional shape (e.g., cylindrical, spherical). In some embodiments, the core region 616 is separated from the reflector region 614 by a core barrier 615, such as a metal wall. The core region 616 can include one or more fuel sources, such as fissile material, for heating the heat pipe layers 611. The reflector region 614 can include one or more materials configured to contain/reflect products generated by burning the fuel in the core region 616 during operation of the system 600. For example, the reflector region 614 can include a liquid or solid material configured to reflect neutrons and/or other fission products radially inward toward the core region 616. In some embodiments, the reflector region 614 can entirely surround the core region 616. In other embodiments, the reflector region 614 may partially surround the core region 616. In some embodiments, the core region 616 can include a control material 617, such as a moderator and/or coolant. The control material 617 can at least partially surround the heat pipe layers 611 in the core region 616 and can transfer heat therebetween.

In the illustrated embodiment, the system 600 further includes at least one heat exchanger 630 (e.g., a steam generator) positioned around the heat pipe layers 611. The heat pipe layers 611 can extend from the core region 616 and at least partially into the reflector region 614 and are thermally coupled to the heat exchanger 630. In some embodiments, the heat exchanger 630 can be positioned outside of or partially within the reflector region 614. The heat pipe layers 611 provide a heat transfer path from the core region 616 to the heat exchanger 630. For example, the heat pipe layers 611 can each include an array of heat pipes that provide a heat transfer path from the core region 616 to the heat exchanger 630. When the system 600 operates, the fuel in the core region 616 can heat and vaporize a fluid within the heat pipes in the heat pipe layers 611, and the fluid can carry the heat to the heat exchanger 630. The heat pipes in the heat pipe layers 611 can then return the fluid toward the core region 616 via wicking, gravity, and/or other means to be heated and vaporized once again.

In some embodiments, the heat exchanger 630 can be similar to the steam generator 530 of FIG. 5 and, for example, can include one or more helically-coiled tubes that wrap around the heat pipe layers 611. The tubes of the heat exchanger 630 can include or carry a working fluid (e.g., a coolant such as water or another fluid) that carries the heat from the heat pipe layers 611 out of the reactor vessel 620 and the containment vessel 610 for use in generating electricity, steam, and/or the like. For example, in the illustrated embodiment the heat exchanger 630 is operably coupled to a turbine 643, a generator 644, a condenser 645, and a pump 646. As the working fluid within the heat exchanger 630 increases in temperature, the working fluid may begin to boil and vaporize. The vaporized working fluid (e.g., steam) may be used to drive the turbine 643 to convert the thermal potential energy of the working fluid into electrical energy via the generator 644. The condenser 645 can condense the working fluid after it passes through the turbine 643, and the pump 646 can direct the working fluid back to the heat exchanger 630 where it can begin another thermal cycle. In other embodiments, steam from the heat exchanger 630 can be routed for direct use in an industrial process, such as an enhanced oil recovery operation described in detail below. Accordingly, steam exiting the heat exchanger 630 can bypass the turbine 643, the generator 644, the condenser 645, the pump 646, etc.

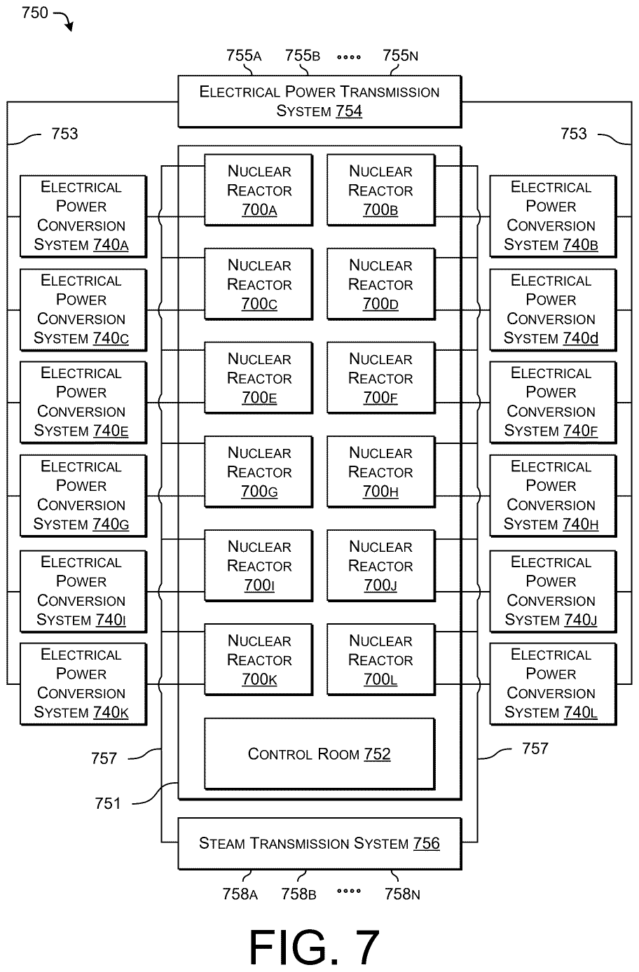

FIG. 7 is a schematic view of a nuclear power plant system 750 including multiple nuclear reactors 700 in accordance with embodiments of the present technology. Each of the nuclear reactors 700 (individually identified as first through twelfth nuclear reactors 700a-l, respectively) can be similar to or identical to the nuclear reactor 700 and/or the nuclear reactor 700 described in detail above with reference to FIGS. 5 and 6. The power plant system 750 (“power plant system 750”) can be “modular” in that each of the nuclear reactors 700 can be operated separately to provide an output, such as electricity or steam. The power plant system 750 can include fewer than twelve of the nuclear reactors 700 (e.g., two, three, four, five, six, seven, eight, nine, ten, or eleven of the nuclear reactors 700), or more than twelve of the nuclear reactors 700. The power plant system 750 can be a permanent installation or can be mobile (e.g., mounted on a truck, tractor, mobile platform, and/or the like). In the illustrated embodiment, each of the nuclear reactors 700 can be positioned within a common housing 751, such as a reactor plant building, and controlled and/or monitored via a control room 752.

Each of the nuclear reactors 700 can be coupled to a corresponding electrical power conversion system 740 (individually identified as first through twelfth electrical power conversion systems 740a-l, respectively). The electrical power conversion systems 740 can include one or more devices that generate electrical power or some other form of usable power from steam generated by the nuclear reactors 700. In some embodiments, multiple ones of the nuclear reactors 700 can be coupled to the same one of the electrical power conversion systems 740 and/or one or more of the nuclear reactors 700 can be coupled to multiple ones of the electrical power conversion systems 740 such that there is not a one-to-one correspondence between the nuclear reactors 700 and the electrical power conversion systems 740.

The electrical power conversion systems 740 can be further coupled to an electrical power transmission system 754 via, for example, an electrical power bus 753. The electrical power transmission system 754 and/or the electrical power bus 753 can include one or more transmission lines, transformers, and/or the like for regulating the current, voltage, and/or other characteristic(s) of the electricity generated by the electrical power conversion systems 740. The electrical power transmission system 454 can route electricity via a plurality of electrical output paths 755 (individually identified as electrical output paths 755a-n) to one or more end users and/or end uses, such as different electrical loads of an integrated energy system.

Each of the nuclear reactors 700 can further be coupled to a steam transmission system 756 via, for example, a steam bus 757. The steam bus 757 can route steam generated from the nuclear reactors 700 to the steam transmission system 756 which in tum can route the steam via a plurality of steam output paths 758 (individually identified as steam output paths 758a-n) to one or more end users and/or end uses, such as different steam inputs of an integrated energy system.

In some embodiments, the nuclear reactors 700 can be individually controlled (e.g., via the control room 752) to provide steam to the steam transmission system 756 and/or steam to the corresponding one of the electrical power conversion systems 740 to provide electricity to the electrical power transmission system 754. In some embodiments, the nuclear reactors 700 are configured to provide steam either to the steam bus 757 or to the corresponding one of the electrical power conversion systems 740 and can be rapidly and efficiently switched between providing steam to either. Accordingly, in some aspects of the present technology the nuclear reactors 700 can be modularly and flexibly controlled such that the power plant system 750 can provide differing levels/amounts of electricity via the electrical power transmission system 754 and/or steam via the steam transmission system 756. For example, where the power plant system 750 is used to provide electricity and steam to one or more industrial process-such as various components of the integrated energy systems, the nuclear reactors 700 can be controlled to meet the differing electricity and steam requirements of the industrial processes.

As one example, during a first operational state of an integrated energy system employing the power plant system 750, a first subset of the nuclear reactors 700 (e.g., the first through sixth nuclear reactors 700a-f) can be configured to provide steam to the steam transmission system 756 for use in the first operational state of the integrated energy system, while a second subset of the nuclear reactors 700 (e.g., the seventh through twelfth nuclear reactors 700g-l) can be configured to provide steam to the corresponding ones of the electrical power conversion systems 740 (e.g., the seventh through twelfth electrical power conversion systems 740g-l) to generate electricity for the first operational state of the integrated energy system. Then, during a second operational state of the integrated energy system when a different (e.g., greater or lesser) amount of steam and/or electricity is required, some or all the first subset of the nuclear reactors 700 can be switched to provide steam to the corresponding ones of the electrical power conversion systems 740 (e.g., the seventh through twelfth electrical power conversion systems 740g-l) and/or some or all of the second subset of the nuclear reactors 700 can be switched to provide steam to the steam transmission system 756 to vary the amount of steam and electricity produced to match the requirements/demands of the second operational state. Other variations of steam and electricity generation are possible based on the needs of the integrated energy system. That is, the nuclear reactors 700 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 700 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A nuclear power plant comprising:
at least one nuclear reactor having a steam generator;
a steam cycle including:
the steam generator,
a first turbine fluidly coupled to the steam generator,
a first condenser fluidly coupled to the first turbine, and
a feedwater heater fluidly coupled to the first condenser and the steam generator;
an intermediate thermal loop including:
the first condenser, and
an evaporator; and
an organic cycle including:
the evaporator,
a second turbine fluidly coupled to the evaporator,
a second condenser fluidly coupled to the second turbine, and
a heat exchanger fluidly coupled to the second condenser and the evaporator.

2. The nuclear power plant according to claim 1, wherein the first turbine is a backpressure or condensing steam turbine.

3. The nuclear power plant according to claim 1, wherein the second turbine is an organic cycle turbine.

4. The nuclear power plant according to claim 1, wherein:
the feedwater heater is an open feedwater heater, and
the feedwater heater is configured to receive steam from the first turbine.

5. The nuclear power plant according to claim 1, wherein:
the heat exchanger is an open heat exchanger, and
the heat exchanger is configured to receive organic vapor from the second turbine.

6. The nuclear power plant according to claim 1, wherein the heat exchanger is a first heat exchanger, the organic cycle further including a second heat exchanger fluidly coupled to the first heat exchanger.

7. The nuclear power plant according to claim 6, wherein:
the second heat exchanger is an open heat exchanger, and
the second heat exchanger is configured to receive organic vapor from the second turbine.

8. A nuclear power plant comprising:
at least one nuclear reactor having a steam generator;
a steam cycle;
a double-walled heat exchanger fluidly connected to the steam cycle; and
an organic cycle including:
the double-walled heat exchanger,
a turbine fluidly coupled to the double-walled heat exchanger,
a condenser fluidly coupled to the turbine, and
a heat exchanger fluidly coupled to the condenser and the double-walled heat exchanger.

9. The nuclear power plant according to claim 8, wherein the turbine is an organic cycle turbine.

10. The nuclear power plant according to claim 8, the steam cycle including:
the steam generator,
a turbine fluidly coupled to the steam generator,
the double-walled heat exchanger fluidly coupled to the turbine, and
a feedwater heater fluidly coupled to the condenser and the steam generator.

11. The nuclear power plant according to claim 10, wherein the turbine fluidly coupled to the steam generator is a backpressure turbine.

12. The nuclear power plant according to claim 10, wherein the turbine fluidly coupled to the steam generator is a condensing turbine.

13. The nuclear power plant according to claim 8, wherein:
the heat exchanger is an open heat exchanger, and
the heat exchanger is configured to receive organic vapor from the turbine.

14. The nuclear power plant according to claim 8, wherein the heat exchanger is a first heat exchanger, the organic cycle further including a second heat exchanger fluidly coupled to the first heat exchanger.

15. The nuclear power plant according to claim 14, wherein:
the second heat exchanger is an open heat exchanger, and
the second heat exchanger is configured to receive organic vapor from the turbine.

16. A method comprising:
producing first steam, utilizing a small modular nuclear reactor;
receiving the first steam into a first turbine, the first turbine receiving the first steam at a first temperature;
receiving the first steam into a first condenser, the first turbine receiving the first steam at a second temperature that is less than the first temperature;
generating second steam within the first condenser by transferring heat from the first steam into a condensate within the first condenser;
generating an organic vapor within an evaporator by transferring heat from the second steam into an organic liquid within the evaporator;
receiving the organic vapor into a second turbine, the second turbine receiving the organic vapor at a third temperature that is less than the second temperature;
receiving the organic vapor into a second condenser;
condensing the organic vapor, via the second condenser, into the organic liquid;
heating, via a heat exchanger, the organic liquid to a fourth temperature that is greater than the third temperature; and
receiving, by the evaporator, the organic liquid at the fourth temperature.

17. The method of claim 16, wherein the first turbine is a condensing turbine.

18. The method of claim 16, wherein the first turbine is a backpressure turbine.

19. The method of claim 16, wherein the heat exchanger is a first heat exchanger, the method further including:
receiving, via a second heat exchanger, the organic liquid at the fourth temperature; and
heating, via the second heat exchanger, the organic liquid to a fifth temperature that is greater than the fourth temperature.

20. The method of claim 16, wherein the heat exchanger is configured to receive organic vapor from the second turbine.
